(19) United States
(12) Patent Application Publication
(10) Pub. No.: US 2006/0168353 A1
(43) Pub. Date: Jul. 27, 2006

(54) Timestamp administration system and image forming apparatus

(75) Inventors: Satoshi Oguri, Osaka-shi (JP); Toshinobu Yoshida, Osaka-shi (JP); Manami Kawamoto, Osaka-shi (JP); Kenichi Mizusu, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/272,127

(22) Filed: Nov. 10, 2005

(30) Foreign Application Priority Data
Nov. 15, 2004 (JP) 2004-331097

(51) Int. Cl. G06F 15/16

(52) U.S. Cl. 709/248

(57) ABSTRACT

A timestamp administration system includes: a timestamp information acquiring section which acquires timestamp information via a network from a timestamp organization of verifying the time; a granting information storage which stores one or more granting information indicating granting of acquiring the timestamp information by the timestamp information acquiring section; a granting information acquiring section which acquires the granting information based on an external input; and a controlling section which causes the timestamp information acquiring section to acquire the timestamp information if it is judged that the granting information acquired by the granting information acquiring section is stored in the granting information storage.

### BACKGROUND OF THE INVENTION

1. Field of the Invention

The present invention relates to a timestamp administration system for administrating acquisition of timestamp information issued from a timestamp organization, and to an image forming apparatus equipped with the timestamp administration system.

2. Description of the Related Art

Heretofore, there has been known a timestamp service for electronically verifying the date and time when an electronic document has been created to prevent falsification of the electronic document or the like. The timestamp service is operated in such a manner that a user accesses a timestamp organization such as a timestamp authority which provides a timestamp service via a network on his or her personal computer, and receives verification regarding the time when an electronic document has been created by issuance of timestamp information. Japanese Unexamined Patent Publication No. 2003-323512 proposes an example of a printing system utilizing the timestamp service. In the printing system, a user requests a timestamp authority of issuance of a timestamp in printing a document, so that the timestamp issued in response to the request is printed along with the document.

Since the timestamp organization charges for the timestamp service, it costs high if all the documents to be printed are printed with the timestamp under the timestamp service. The arrangement recited in the above publication has not taken a measure for suppressing the cost relating to the timestamp service at the time of printing a document.

### SUMMARY OF THE INVENTION

In view of the above problems residing in the prior art, it is an object of the present invention to provide a timestamp administration system that enables to suppress the cost relating to processing of data utilizing the timestamp service, and an image forming apparatus provided with the timestamp administration system.

An aspect of the invention is directed to a timestamp administration system comprising: a timestamp information acquiring section which acquires timestamp information via a network from a timestamp organization of verifying the time; a granting information storage which stores one or more granting information indicating granting of acquiring the timestamp information by the timestamp information acquiring section; a granting information acquiring section which acquires the granting information based on an external input; and a controlling section which causes the timestamp information acquiring section to acquire the timestamp information if it is judged that the granting information acquired by the granting information acquiring section is stored in the granting information storage.

In the above arrangement, if it is judged that the granting information acquired by the granting information acquiring section is stored in the granting information storage, the controlling section causes the timestamp information acquiring section to acquire the timestamp information. Thus, a constraint is made, in which the timestamp information acquiring section acquires the timestamp information from the timestamp organization only in the condition that the granting information acquired by the granting information acquiring section is judged to be coincident with or identical to the granting information stored in the granting information storage.

According to the above arrangement, the constraint is made, in which the user having the granting information indicating granting of acquiring timestamp information is granted to acquire timestamp information in processing the data, without granting all the possible users to use the timestamp service all the time. This arrangement contributes to cost reduction relating to processing of data utilizing the timestamp service.

Further, it is possible to grant acquisition of timestamp information exclusively to the user who is granted to acquire timestamp information, or to data to which timestamp information is to be attached by causing the granting information storage to store the granting information relating to the user who is granted to acquire timestamp information. This arrangement provides a flexible criteria concerning granted use of the timestamp service.

These and other objects, features and advantages of the present invention will become more apparent upon reading of the following detailed description along with the accompanying drawings.

### BRIEF DESCRIPTION OF THE DRAWINGS

FIG. 1 is an illustration showing a network configuration comprised of an image forming apparatus to which a timestamp administration system of the invention is applied, and a computer system connected to the image forming apparatus.

FIG. 2 is a block diagram schematically showing an internal arrangement of a complex machine as an example of the image forming apparatus shown in FIG. 1.

FIG. 3 is a flowchart showing a first embodiment of timestamp administration used in the complex machine shown in FIG. 1 in the case where data of a read document image is stored.

FIG. 4 is a flowchart showing a second embodiment of timestamp administration used in the complex machine shown in FIG. 1 in the case where data of a read document image is stored.

FIG. 5 is a flowchart showing a third embodiment of timestamp administration used in the complex machine shown in FIG. 1 in the case where a confirmation message indicating that data has been received is sent.

### DETAILED DESCRIPTION OF THE PREFERRED EMBODIMENTS

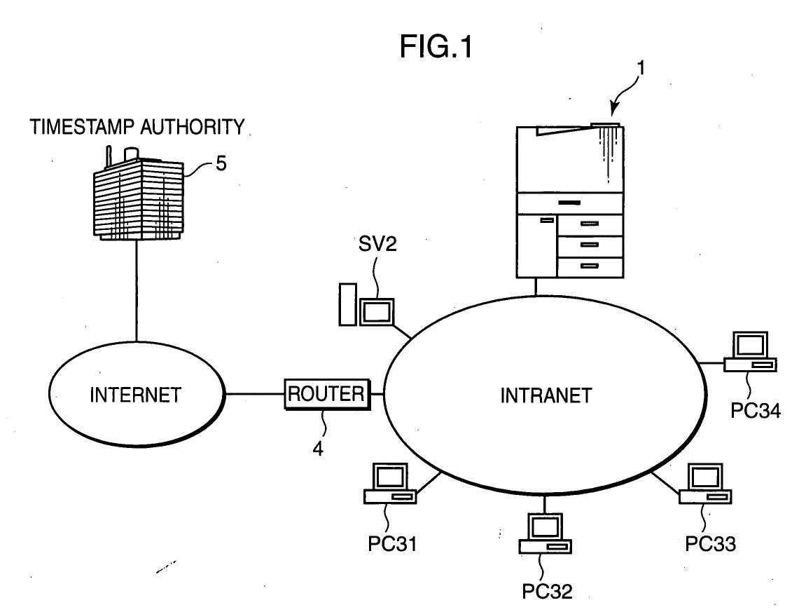

In the following, description is made, referring to the drawings, on a timestamp administration system as an embodiment of the invention, and an image forming apparatus to which the timestamp administration system is applied. FIG. 1 is an illustration showing a network configuration comprised of the image forming apparatus to which the timestamp administration system is applied, and a computer system connected to the image forming apparatus.

A complex machine 1 as an example of the image forming apparatus has functions of a copier, a fax, a printer, and a scanner. The complex machine 1 is constructed in such a manner that data of a document image read by a scanner is stored in an Hard Disk Drive of the complex machine 1, or in respective storages of a server computer SV2, and personal computers PCs 31 through 34 connected to the complex machine 1 via an intranet or the like. The complex machine 1 is also operative to print out data stored in the internal memory device of the complex machine 1 or print out data transmitted from the server computer SV2 or the PCs 31 through 34.

Also, the network comprised of the complex machine 1, the server computer SV2, and the PCs 31 through 34 are connected to the Internet via a router 4. The complex machine 1 is constructed in such a manner that a user is allowed to access a timestamp authority 5 as an example of a timestamp organization, and to indirectly via the server computer SV2 or directly receive a timestamp service provided by the timestamp authority 5 of electronically verifying the date and time when an electronic document has been created, or an e-mail sent from an external personal computer or a like device.

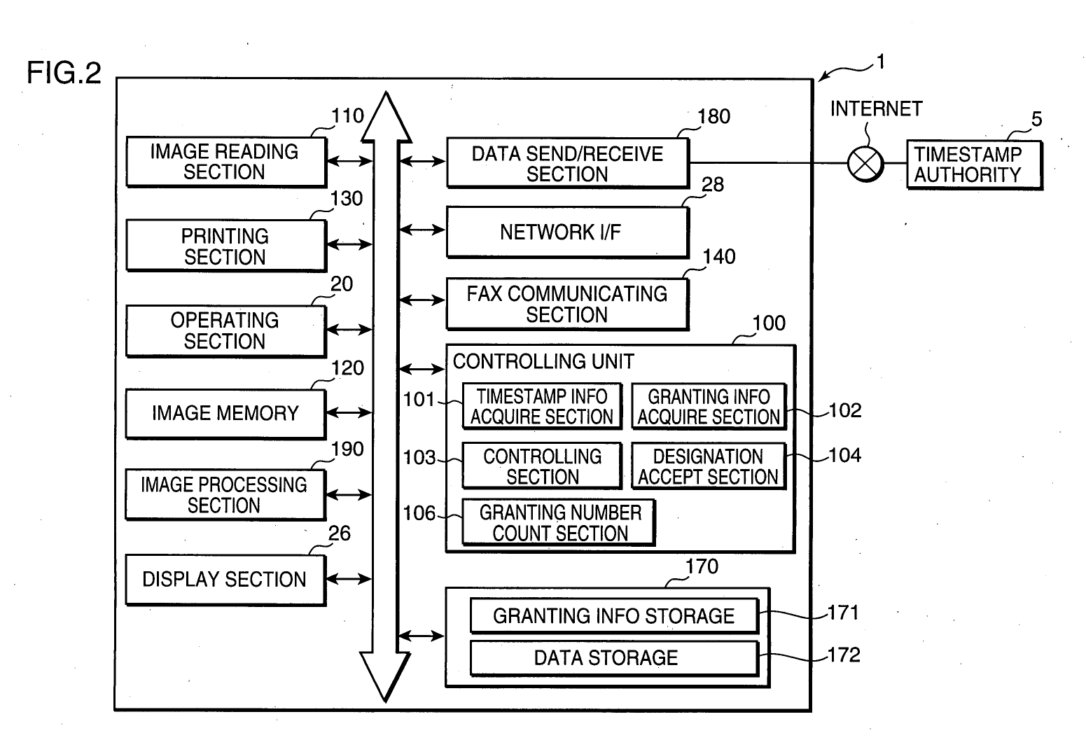

FIG. 2 is a block diagram schematically showing an internal arrangement of the complex machine 1. The complex machine 1 includes a control unit 100 for controlling operations of the respective components of the complex machine 1, an image reading section 110 provided with the scanner for reading a document image, an image memory 120 for temporarily storing data of the document image read by the image reading section 110, and a printing section 130 for printing the document data read by the image reading section 110 or data stored in a data storage 172 of a hard disk drive (HDD) 170. The image reading section 110 is an example of a data input accepting section, and the printing section 130 is an example of a confirmation message outputting section or a data outputting section.

Also, the complex machine 1 includes: a facsimile communicating section 140 for executing various functions necessary for facsimile communication, and for receiving image data from an external facsimile device via a public telephone line; an operating section 20, which is provided with a data transmission start key, a ten key, and an index key, and which is adapted to accept user's designation relating to various operations such as the number of copies to be printed, and input of granting information, which will be described later; and a display section 26 provided with a liquid crystal display (LCD) for displaying an operation guidance for the user. The display section 26 is an example of the confirmation message outputting section or the data outputting section. The display section 26 may have a touch panel function so that the user's designation relating to various operations including input of the granting information is accepted.

The HDD 170 of the complex machine 1 has a granting information storage 171, and the data storage 172. The data storage 172 is a storage for storing data read by the image reading section 110. The granting information storage 171 stores one or more granting information indicating granting of acquiring timestamp information by a timestamp information acquiring section 101. The granting information storage 171 stores one or more data format for granting acquisition of timestamp information in the case where the format of data to be handled by the complex machine 1 is used as the granting information.

Referring to FIG. 2, the controlling unit 100 includes the timestamp information acquiring section 101, a granting information acquiring section 102, a controlling section 103, a designation accepting section 104, and a granting number counting section 106.

The timestamp information acquiring section 101 is operative to acquire timestamp information from the timestamp authority 5 via the Internet. The timestamp information is information for electronically verifying the date and time or the like when an electronic document has been created, and is sometimes simply called as a timestamp or the like.

The granting information acquiring section 102 is operative to acquire granting information sent from the operating section 20 or the display section 26 in response to user's manipulation on the operating section 20 or the touch panel function of the display section 26. The granting information includes, for instance, identification (ID) information, which is assigned to individual users of the complex machine 1, and is used to judge whether a specific user is granted to acquire timestamp information issued from the timestamp authority 5 by the timestamp information acquiring section 101. Further, in the case where the format of data to be handled by the complex machine 1 such as fax data format and e-mail format is used as the granting information, the granting information acquiring section 102 is operative to identify the format of data received by a data sending/receiving section 180, the facsimile communication section 140 or the like, and acquire the identified data format as the granting information.

The controlling section 103 is operative to control an overall control operation of the complex machine 1. Also, the controlling section 103 judges whether the granting information acquired by the granting information acquiring section 102 is stored in the granting information storage 171. If the controlling section 103 judges that the granting information is stored in the granting information storage 171, the controlling section 103 controls the timestamp information acquiring section 101 to acquire timestamp information issued from the timestamp authority 5. The respective controls to be performed by the controlling section 103 will be described later one by one referring to the flowcharts.

The designation accepting section 104 is operative to accept designation relating to processing of data, which is entered by the user by way of the operating section 20 or the touch panel function of the display section 26. The designation includes designation for storing or printing data read by the image reading section 110, and designation for printing data stored in the data storage 172 of the HDD 170.

The granting number counting section 106 is operative to count the accumulative number of times of acquiring timestamp information by the timestamp information acquiring section 101 with respect to each of the granting information such as the ID information or the data format acquired by the granting information acquiring section 102.

Also, the complex machine 1 includes an image processing section 190 for performing editing/processing of image data read by the image reading section 110, such as coding/decoding, enlargement/reduction, and compression/decompression, and a network interface (I/F) 28, which is used for various data communication between the server computer SV, and the PCs 31 through 34.

The data sending/receiving section 180 is operative to request the timestamp authority 5 of timestamp information via the Internet, and to send/receive the timestamp information as requested under the control of the controlling section 103. Also, the data sending/receiving section 180 has a function of sending and receiving an e-mail to and from an external personal computer or a like device via the Internet. The router 4 is not illustrated in FIG. 2.

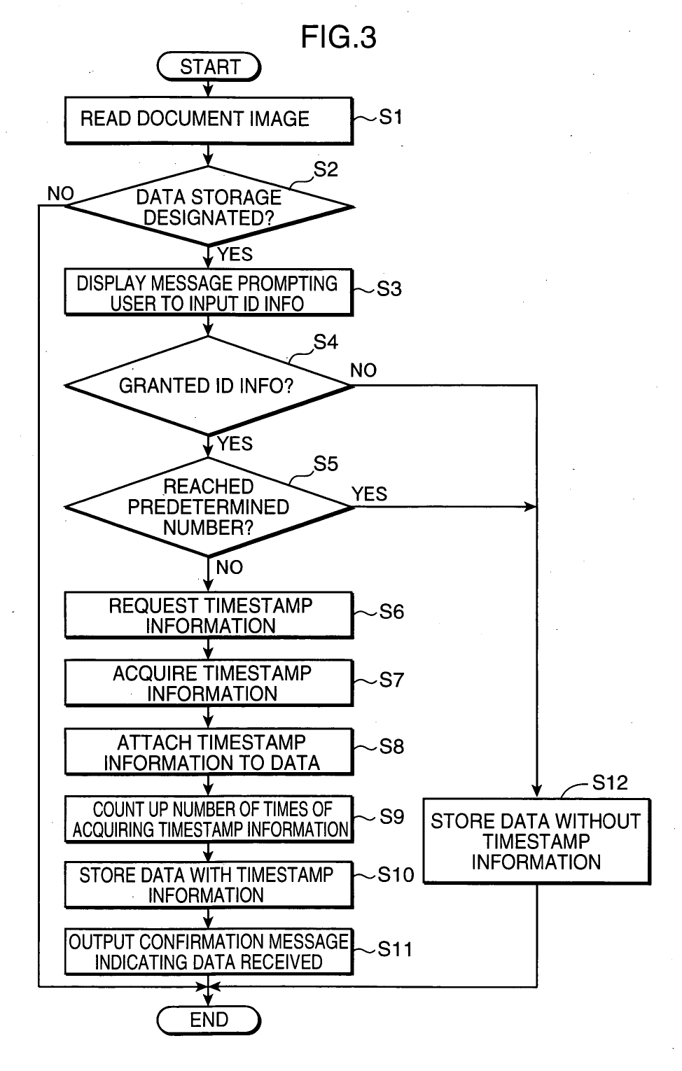

Now, a first embodiment of timestamp administration by the complex machine 1 is described referring to FIG. 3. FIG. 3 is a flowchart showing the first embodiment of timestamp administration in the case where the complex machine 1 is so designed as to store data of a document image read by the image reading section 110. When a document image is read by the image reading section 110 (Step S1), and designation to store data of the document image into the data storage 172 of the HDD 170 is entered by the user by way of the operating section 20 or the like (YES in Step S2), the controlling section 103 causes the display section 26 to display a message prompting the user to enter his or her ID information (Step S3). If there is no designation from the user to store the data after the reading of the document image (NO in Step S2), the routine ends.

After Step S3, when the ID information is entered by the user, and the granting information acquiring section 102 acquires the ID information, the controlling section 103 judges whether the acquired ID information coincides with the ID information stored in the granting information storage 171, namely, whether the acquired ID information indicates granting of acquiring timestamp information (Step S4).

If the ID information entered by the user indicates granting of acquiring timestamp information (YES in Step S4), the controlling section 103 judges whether the accumulative number of times of acquiring timestamp information using the ID information has reached a predetermined number e.g. 10 times a month, based on the number counted by the granting number counting section 106 (Step S5). If the accumulative number of times of acquiring timestamp information has not reached the predetermined number (NO in Step S5), the timestamp information acquiring section 101 requests the timestamp authority 5 of sending timestamp information (Step S6).

Then, the timestamp information acquiring section 101 acquires the timestamp information as requested from the timestamp authority 5 via the data sending/receiving section 180 (Step S7). Subsequently, the controlling section 103 attaches the timestamp information acquired by the timestamp information acquiring section 101 to the document image data read by the image reading section 110 in Step S1. Then, the granting number counting section 106 counts up the number of times of acquiring timestamp information concerning the ID information (Step S9), and the controlling section 103 stores the data attached with the timestamp information in the data storage 172 (Step S10). After the data storage, the controlling section 103 causes the printing section 130 to print a confirmation message indicating that the timestamp information has been attached to the data at the time of the data storage to notify the user that the timestamp information has been attached (Step S11). Thus, the routine ends. Alternatively, an output of a confirmation message may be realized by causing the display section 26 to display a confirmation message under the control of the controlling section 103, in place of causing the printing section 130 to print out the confirmation message.

If the ID information entered by the user does not indicate that acquiring of timestamp information is granted (NO in Step S4), and if the accumulative number of times of acquiring timestamp information has reached the predetermined number (YES in Step S5), acquisition of timestamp information is not implemented, and the controlling section 103 stores the data without timestamp information in the data storage 172 (Step S12) Thus, the routine ends.

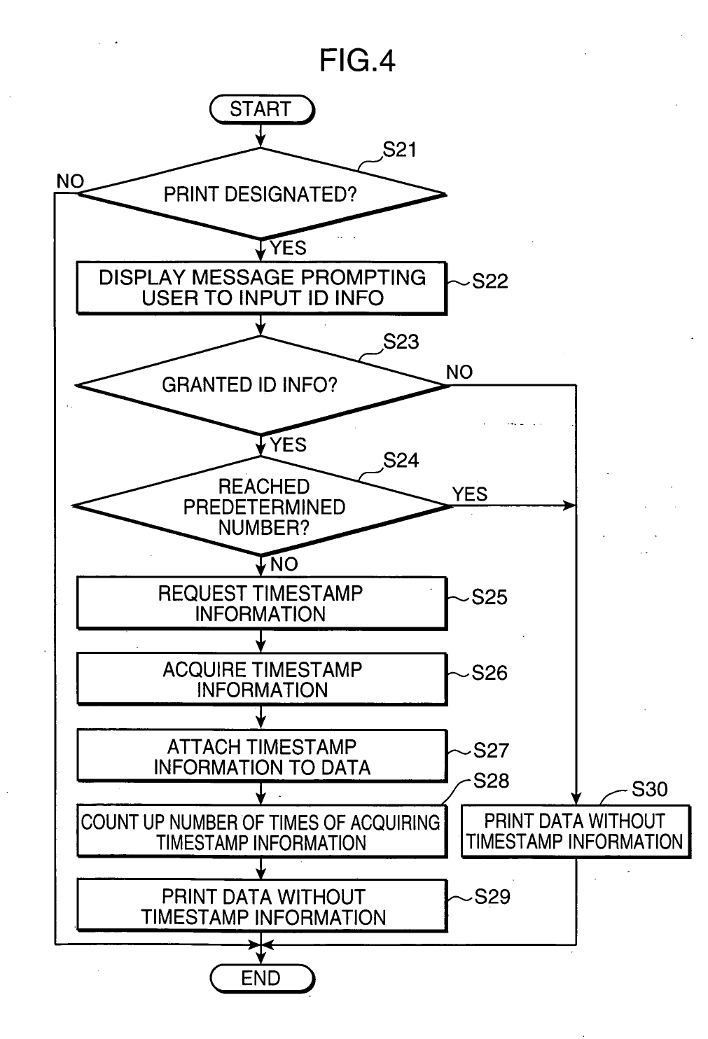

Next, a second embodiment of timestamp administration by the complex machine 1 is described referring to FIG. 4. FIG. 4 is a flowchart showing the second embodiment of timestamp administration in the case where the complex machine 1 is so designed as to store data of a document image read by the image reading section 110 for printing. The second embodiment is directed to timestamp administration to be implemented when document image data stored in the data storage 172 of the HDD 170 is read out and printed.

When designation to print out the data stored in the data storage 172 of the HDD 170 is entered by the user by way of the operating section 20 or the like (YES in Step S21), the controlling section 103 causes the display section 26 to display a message prompting the user to enter his or her ID information (Step S22). If the ID information entered by the user indicates granting of acquiring timestamp information (YES in Step S23), and if the accumulative number of times of acquiring timestamp information has not reached the predetermined number (NO in Step S24), the timestamp information acquiring section 101 is operative to acquire timestamp information from the timestamp authority 5 (Steps S25, S26), and then, the controlling section 103 attaches the acquired timestamp information to the readout data which has been designated in Step S21 for printing (Step S27). Then, the granting number counting section 106 counts up the number of times of acquiring timestamp information concerning the ID information (Step S28), and the controlling section 103 causes the printing section 130 to print out the data attached with the timestamp information (Step S29). Thus, the routine ends.

If, on the other hand, the ID information entered by the user does not indicate granting of acquiring timestamp information (NO in Step S23), and if the number of times of acquiring timestamp information has reached the predetermined number (YES in Step S24), timestamp information is not acquired, and the controlling section 103 causes the printing section 130 to print data without timestamp information (Step S30), and the routine ends.

As described in the first and the second embodiments, a constraint is made in which the user having granting information indicating granting of acquiring timestamp information is exclusively granted to acquire timestamp information in storage of data read by the image reading section 110 or printout of data stored in the data storage 172, without granting all the possible users to use the timestamp service all the time. This arrangement contributes to cost reduction relating to processing of data utilizing the timestamp service.

Also, the granting information storage 171 exclusively stores the ID information of a user who is granted to acquire timestamp information. This arrangement provides administration, in which acquiring of timestamp information is granted exclusively to the user who is granted to acquire timestamp information, thereby providing a flexible criteria concerning granted use of the timestamp service.

Further, acquisition of timestamp information is granted up to the predetermined number of times with respect to each of the granting information. This arrangement restricts acquisition of timestamp information in terms of the number of times with respect to each of the ID information, which provides a further flexible criteria concerning granted use of the timestamp service.

Furthermore, since a confirmation message indicating that timestamp information has been attached to the data at the time of the data storage is printed or displayed, the user can securely recognize that the timestamp information has been attached to the stored data.

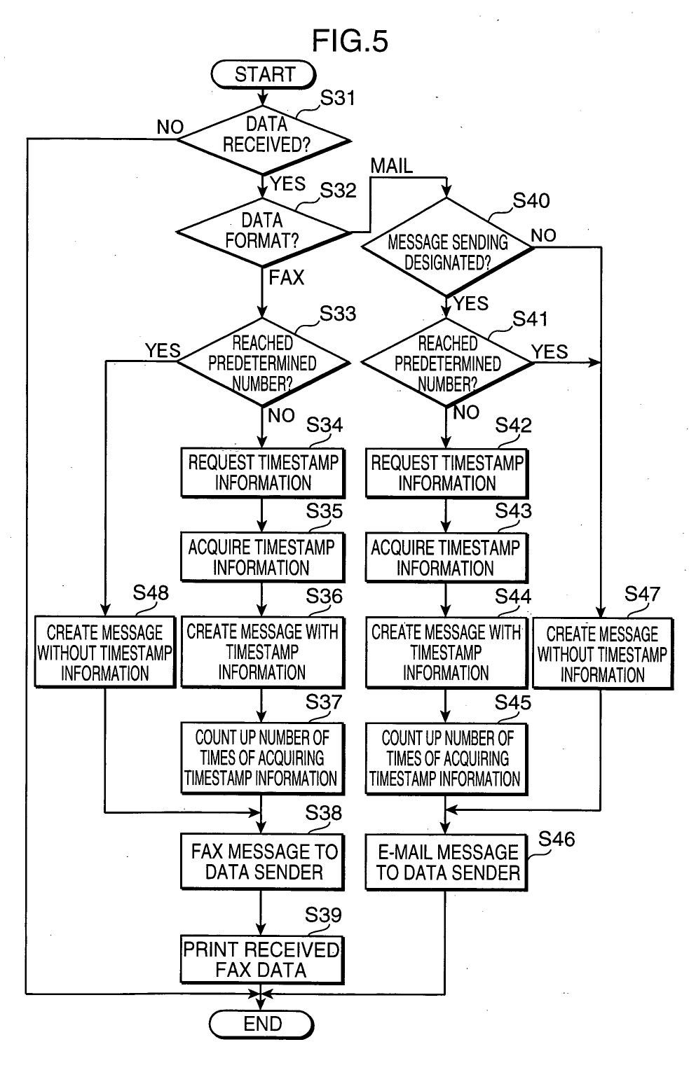

Next, a third embodiment of timestamp administration by the complex machine 1 is described referring to FIG. 5. FIG. 5 is a flowchart showing the third embodiment of timestamp administration in the case where the complex machine 1 is so designed as to send a confirmation message indicating data has been received. The third embodiment is directed to timestamp administration to be implemented when data such as fax data or e-mail has been received. The granting information acquiring section 102 is operative to identify the format of data received by the data sending/receiving section 180 and by the facsimile communicating section 140 as an example of the data receiving section, and uses the identified data format as granting information. In other words, the granting information acquiring section 102 grants acquiring of timestamp information when the received data format is of fax data or of e-mail data.

When the data sending/receiving section 180 or the facsimile communicating section 140 receives data from an external device (YES in Step S31), the granting information acquiring section 102 identifies the format of the received data (Step S32).

If the data format identified by the granting information acquiring section 102 is fax data format (FAX in Step S32), the controlling section 103 retrieves the accumulative number of times of acquiring timestamp information at the time of receiving the fax data, based on the number counted by the granting number counting section 106 (Step S33).

If the accumulative number of times of acquiring timestamp information at the time of receiving the fax data has reached a predetermined number e.g. 100 times a month (YES in Step S33), the controlling section 103 creates a confirmation message indicating that fax data has been received without attaching timestamp information, namely, without causing the timestamp information acquiring section 101 to acquire timestamp information (Step S48), and causes the facsimile communicating section 140 to send the created confirmation message to the sender of the fax data via facsimile (Step S38) Thereafter, the controlling section 103 causes the printing section 130 to print out the received fax data (Step S39), and the routine ends. Alternatively, Step S38 may follow Step S39.

If the accumulative number of times of acquiring timestamp information at the time of receiving the fax data has not reached the predetermined number (NO in Step S33), the timestamp information acquiring section 101 requests the timestamp authority 5 of timestamp information via the data sending/receiving section 180 (Step S34). In response to the request, the timestamp authority 5 issues timestamp information, and the timestamp information acquiring section 101 acquires the timestamp information issued by the timestamp authority 5 via the data sending/receiving section 180 (Step S35). Subsequently, the controlling section 103 creates a confirmation message indicating that the fax data has been received, with the timestamp information being attached thereto (Step S36), and the granting number counting section 106 counts up the number of times of granting acquiring of timestamp information at the time of receiving the fax data (Step S37). Thereafter, the controlling section 103 causes the facsimile communicating section 140 to send, to the sender of the fax data via facsimile, a confirmation message indicating that the fax data has been received, with the timestamp information being attached thereto (Step S38), and causes the printing section 130 to print out the received fax data (Step S39). Thus, the routine ends.

If the data format identified by the granting information acquiring section 102 is an e-mail format (MAIL in Step S32), the controlling section 103 judges whether sending a confirmation message that data has been received with timestamp information being attached thereto to the data sender has been designated by manipulation of the user on the operating section 20 or the like (Step S40). If sending of the confirmation message to the data sender has not been designated (NO in Step S40), the controlling section 103 creates a confirmation message that an e-mail has been received without attaching timestamp information, namely, without causing the timestamp acquiring section 101 to acquire timestamp information (Step S47), and causes the data sending/receiving section 180 to send via e-mail the confirmation message that the e-mail has been received to the sender of the e-mail (Step S46). Thus, the routine ends.

On the other hand, if sending a confirmation message to the data sender has been designated (YES in Step S40), the controlling section 103 judges whether the accumulative number of times of acquiring timestamp information at the time of receiving the e-mail has reached a predetermined number (Step S41). If the accumulative number of times of acquiring timestamp information at the time of receiving the e-mail has reached the predetermined number (YES in Step S41), the controlling section 103 creates a confirmation message indicating that the e-mail has been received without attaching timestamp information (Step S47), and causes the data sending/receiving section 180 to send via e-mail the confirmation message to the sender of the e-mail (Step S46). Thus, the routine ends.

If the accumulative number of times of acquiring timestamp information at the time of receiving the e-mail has not reached the predetermined number (NO in Step S41), the timestamp information acquiring section 101 requests the timestamp authority 5 of timestamp information via the data sending/receiving section 180 (Step S42). In response to the request, the timestamp authority 5 issues timestamp information, and the timestamp information acquiring section 101 acquires the timestamp information issued by the timestamp authority 5 via the data sending/receiving section 180 (Step S43). Then, the controlling section 103 creates a confirmation message indicating that the e-mail has been received, with the timestamp information being attached thereto (Step S44), and causes the granting number counting section 106 to count up the number of times of granting acquiring of timestamp information at the time of receiving the e-mail (Step S45). Thereafter, the controlling section 103 causes the data sending/receiving section 180 to send via e-mail the confirmation message with the timestamp information being attached thereto to the sender of the e-mail (Step S46). Thus, the routine ends.

In the complex machine 1 thus constructed, determination as to whether a confirmation message indicating that the data has been received with timestamp information being attached thereto is to be sent is made based on the format of the data sent from the external device. Also, the user can arbitrarily determine whether a confirmation message with timestamp information being attached thereto is to be sent to the data sender by setting designation to send the confirmation message with timestamp information being attached thereto to the data sender.

In the third embodiment, the confirmation message is sent to the data sender. Alternatively, the confirmation message may be sent to a predetermined sender other then the data sender. Further alternatively, the confirmation message may be sent with at least part of the data received in Step S31 being attached thereto.

The judgment of Step S31 is made on a premise that the received data is fax data or an e-mail. Alternatively, a judgment may be made whether the received data is document data e.g. scanned data, which has been read by the image reading section 110, or data, e.g. page description language, which has been received from an external PC via the network I/F 28 as an example of the data receiving section for printing, and a judgment may be made as to whether timestamp information is acquired based on the format of the respective data.

In the third embodiment, a confirmation message is sent with respect to all the fax data. Alternatively, a judgment may be made as to whether a confirmation message is sent based on information such as a so-called F-code attached to all the fax data, or header information in the received e-mail so that the confirmation message is sent to a specific user or users. The F-code is a communication function in compliance with ITU-T G3 standard to keep confidentiality of document for communication.

The invention is not limited to the foregoing, and various modifications are applicable to the invention. For instance, in the embodiments, ID information to be inputted by the user, or the format of received data is used as the granting information. Alternatively, a judgment may be made as to whether acquisition of timestamp information is granted by using information relating to the data sender, such as a personal computer from which the data is sent, or a sender of fax data or an e-mail.

In the embodiment, description is made on the arrangement in which the inventive timestamp administration system is applied to the complex machine 1. The inventive timestamp administration system is not specifically limited to the complex machine 1. Alternatively, it is possible to apply the inventive timestamp administration system to an image forming apparatus other than the complex machine 1.

Also, the arrangements and the processes shown in FIGS. 1 through 5 are merely examples of the invention. The invention is not limited to the aforementioned arrangements and processes.

To summarize the invention, a timestamp administration system according to an aspect of the invention comprises: a timestamp information acquiring section which acquires timestamp information via a network from a timestamp organization of verifying the time; a granting information storage which stores one or more granting information indicating granting of acquiring the timestamp information by the timestamp information acquiring section; a granting information acquiring section which acquires the granting information based on an external input; and a controlling section which causes the timestamp information acquiring section to acquire the timestamp information if it is judged that the granting information acquired by the granting information acquiring section is stored in the granting information storage.

In the above arrangement, if it is judged that the granting information acquired by the granting information acquiring section is stored in the granting information storage, the controlling section causes the timestamp information acquiring section to acquire the timestamp information. Thus, a constraint is made, in which the timestamp information acquiring section acquires the timestamp information from the timestamp organization only in the condition that the granting information acquired by the granting information acquiring section is judged to be coincident with or identical to the granting information stored in the granting information storage.

According to the above arrangement, the constraint is made, in which the user having the granting information indicating granting of acquiring timestamp information is granted to acquire timestamp information in processing the data, without granting all the possible users to use the timestamp service all the time. This arrangement contributes to cost reduction relating to processing of data utilizing the timestamp service.

Further, it is possible to grant acquisition of timestamp information exclusively to the user who is granted to acquire timestamp information, or to data to which timestamp information is to be attached by causing the granting information storage to store the granting information relating to the user who is granted to acquire timestamp information. This arrangement provides a flexible criteria concerning granted use of the timestamp service.

Preferably, the timestamp administration system further comprises: a data input accepting section which accepts input of data; a data storage which stores the data accepted by the data input accepting section; and a designation accepting section which accepts designation relating to processing of the data, wherein the controlling section causes the data storage to store the data with the time information acquired by the timestamp information acquiring section being attached thereto if it is judged that the granting information is stored in the granting information storage, and that the designation accepting section accepts the designation to store the data into the data storage.

In the above arrangement, the controlling section causes the timestamp information acquiring section to acquire the timestamp information, and causes the data storage to store the acquired timestamp information with the data accepted by the data input accepting section being attached thereto only in the condition that the granting information acquired by the granting information acquiring section is stored in the granting information storage. Thus, a constraint is made regarding the acquisition of timestamp information at the time of the data storage.

According to the above arrangement, the constraint is made, in which the user having the granting information indicating granting of acquiring timestamp information is granted to store the data with the timestamp information being attached thereto in the data storage at the time of storing the data, without granting all the possible users to use the timestamp service all the time. This arrangement contributes to cost reduction relating to storing of data with the timestamp information being attached thereto.

Preferably, the timestamp administration system further comprises: a confirmation message outputting section which outputs a confirmation message indicating that the data with the timestamp information being attached thereto is stored in the data storage, wherein the controlling section causes the confirmation message outputting section to output the confirmation message if it is judged that the data with the timestamp information being attached thereto is stored in the data storage.

In the above arrangement, the controlling section causes the confirmation message outputting section to output the confirmation message if the data with the timestamp information attached being thereto is stored in the data storage. This arrangement securely notifies the user that the timestamp information has been attached to the data at the time of the data storage.

Preferably, the timestamp administration system further comprises: a data storage which stores data; a data outputting section which outputs the data stored in the data storage; and a designation accepting section which accepts designation relating to processing of the data, wherein the controlling section causes the timestamp information acquiring section to acquire the timestamp information, and causes the data outputting section to output the data with the timestamp information being attached thereto if it is judged that the designation accepting section accepts the designation to output the data stored in the data storage.

In the above arrangement, the controlling section causes the timestamp information acquiring section to acquire the timestamp information, and causes the data outputting section to output the data with the acquired timestamp information being attached thereto only in the condition that the designation accepting section accepts the designation to output the data stored in the data storage, and that the granting information acquired by the granting information acquiring section coincides with the granting information stored in the granting information storage. Thus, a constraint is made regarding the acquisition of timestamp information at the time of data output.

According to the above arrangement, the constraint is made, in which the designation accepting section accepts the designation to output the data stored in the data storage, and the user having the granting information indicating granting of acquiring timestamp information is granted to output the data with the timestamp information being attached thereto in outputting the data, without granting all the possible users to use the timestamp service all the time. This arrangement contributes to cost reduction relating to output of data with the timestamp information being attached thereto.

Preferably, the granting information acquiring section uses a format of the data as the granting information, and the controlling section causes the timestamp information acquiring section to acquire the timestamp information based on a judgment as to whether the data format accepted by the granting information acquiring section is stored in the granting information storage.

In the above arrangement, the granting information acquiring section uses the format of the data received by the data receiving section as the granting information if the data from the external device has been received by the data receiving section, and a judgment is made as to whether the controlling section allows the timestamp information acquiring section to acquire the timestamp information based on the format of the received data. This arrangement enables to determine whether the confirmation message indicating that the data has been received is to be sent to the data sender based on the format of the received data.

According to the above arrangement, since the determination as to whether acquisition of timestamp information is to be granted is made based on the format of the received data, the criteria concerning granted use of the timestamp service can be made further flexible.

Preferably, the timestamp administration system further comprises: a data receiving section which receives data from an external device as a sender of the data; and a confirmation message sending section which sends a confirmation message indicating that the data has been received by the data receiving section to the data sender, wherein the granting information acquiring section uses a format of the data received by the data receiving section as the granting information, and the controlling section causes the timestamp information acquiring section to acquire the timestamp information, and causes the confirmation message sending section to send the confirmation message with the timestamp information being attached thereto if it is judged that the data format accepted by the granting information acquiring section is stored in the granting information storage.

In the above arrangement, the controlling section is operative to judge whether the confirmation message with the timestamp information being attached thereto is to be sent to the data sender based on the format of the data received by the data receiving section. This arrangement enables to determine whether the confirmation message with the timestamp information is to be sent based on the format of the received data.

According to the above arrangement, since the determination as to whether the confirmation message is to be sent to the data sender is made based on the format of the received data, the criteria concerning granted use of the timestamp service can be made further flexible.

Preferably, the timestamp administration system further comprises: a transmission designation accepting section which accepts designation of causing the confirmation message sending section to send the confirmation message with the timestamp information being attached thereto, the designation being entered by the user, wherein the controlling section causes the timestamp acquiring section to acquire the timestamp information, and causes the confirmation message sending section to send the confirmation message with the timestamp information being attached thereto, irrespective of the data format accepted by the granting information acquiring section if it is judged that the transmission designation accepting section accepts the designation to send the confirmation message with the timestamp information being attached thereto.

In the above arrangement, the controlling section causes the confirmation message sending section to send the confirmation message with the timestamp information being attached thereto irrespective of the format of the received data, if the transmission designation accepting section accepts the designation to send the confirmation message with the timestamp information being attached thereto. This arrangement allows the user to determine whether the confirmation message with the timestamp information being attached thereto is to be sent to the data sender.

According to the above arrangement, the user is allowed to determine whether the confirmation message with the timestamp information being attached thereto is to be sent to the data sender by the confirmation message sending section by inputting designation to send the confirmation message with the timestamp information being attached thereto.

Preferably, the granting information acquiring section uses information indicating the sender of the data received by the data receiving section, as the granting information, in place of using the data format.

The above arrangement enables to determine whether the confirmation message with the timestamp information being attached thereto is to be sent to the data sender in accordance with the sender of the data received by the data receiving section.

According to the above arrangement, determination is made as to whether the confirmation message with the timestamp information being attached thereto is to be sent to the data sender in accordance with the sender of the data received by the data receiving section.

Preferably, the timestamp administration system further comprises: a granting number counting section which counts up the number of times of acquiring the timestamp information by the timestamp information acquiring section with respect to each of the granting information, wherein the controlling section allows the timestamp information acquiring section to acquire the timestamp information up to a predetermined number of times, based on the number of times counted by the granting number counting section.

In the above arrangement, the controlling section allows the timestamp information acquiring section to acquire timestamp information up to the predetermined number of times with respect to each of the granting information, based on the number counted by the granting number counting section. Thus, a constraint is made regarding the acquisition of timestamp information in terms of the number of times of acquiring timestamp information with respect to each of the granting information.

According to the above arrangement, the constraint is made regarding the acquisition of timestamp information in terms of the number of times of acquiring timestamp information with respect to each of the granting information by allowing acquisition of timestamp information up to the predetermined number of times with respect to each of the granting information. This arrangement enables to make the criteria concerning granted use of the timestamp service further flexible.

Another aspect of the invention is directed to an image forming apparatus comprising the timestamp administration system having one or more of the features as mentioned above.

The above arrangement enables to provide an image forming apparatus having the operations and effects as recited concerning the above arrangements.

This application is based on Japanese Patent Application No. 2004-331097 filed on Nov. 15, 2004, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A timestamp administration system comprising:
a timestamp information acquiring section which acquires timestamp information via a network from a timestamp organization of verifying the time;
a granting information storage which stores one or more granting information indicating granting of acquiring the timestamp information by the timestamp information acquiring section;
a granting information acquiring section which acquires the granting information based on an external input; and
a controlling section which causes the timestamp information acquiring section to acquire the timestamp information if it is judged that the granting information acquired by the granting information acquiring section is stored in the granting information storage.

2. The timestamp administration system according to claim 1, further comprising:
a data input accepting section which accepts input of data;
a data storage which stores the data accepted by the data input accepting section; and
a designation accepting section which accepts designation relating to processing of the data, wherein
the controlling section causes the data storage to store the data with the time information acquired by the timestamp information acquiring section being attached thereto if it is judged that the granting information is stored in the granting information storage, and that the designation accepting section accepts the designation to store the data into the data storage.

3. The timestamp administration system according to claim 2, further comprising:
a confirmation message outputting section which outputs a confirmation message indicating that the data with the timestamp information being attached thereto is stored in the data storage, wherein
the controlling section causes the confirmation message outputting section to output the confirmation message if it is judged that the data with the timestamp information being attached thereto is stored in the data storage.

4. The timestamp administration system according to claim 2, wherein
the granting information acquiring section uses a format of the data as the granting information, and
the controlling section causes the timestamp information acquiring section to acquire the timestamp information based on a judgment as to whether the data format accepted by the granting information acquiring section is stored in the granting information storage.

5. The timestamp administration system according to claim 2, further comprising:
a granting number counting section which counts up the number of times of acquiring the timestamp information by the timestamp information acquiring section with respect to each of the granting information, wherein
the controlling section allows the timestamp information acquiring section to acquire the timestamp information up to a predetermined number of times, based on the number of times counted by the granting number counting section.

6. The timestamp administration system according to claim 1, further comprising:
a data storage which stores data;
a data outputting section which outputs the data stored in the data storage; and
a designation accepting section which accepts designation relating to processing of the data, wherein
the controlling section causes the timestamp information acquiring section to acquire the timestamp information, and causes the data outputting section to output the data with the timestamp information being attached thereto if it is judged that the designation accepting section accepts the designation to output the data stored in the data storage.

7. The timestamp administration system according to claim 6, further comprising:
a granting number counting section which counts up the number of times of acquiring the timestamp information by the timestamp information acquiring section with respect to each of the granting information, wherein
the controlling section allows the timestamp information acquiring section to acquire the timestamp information up to a predetermined number of times, based on the number of times counted by the granting number counting section.

8. The timestamp administration system according to claim 1, further comprising:
a data receiving section which receives data from an external device as a sender of the data; and
a confirmation message sending section which sends a confirmation message indicating that the data has been received by the data receiving section to the data sender, wherein
the granting information acquiring section uses a format of the data received by the data receiving section as the granting information, and
the controlling section causes the timestamp information acquiring section to acquire the timestamp information, and causes the confirmation message sending section to send the confirmation message with the timestamp information being attached thereto if it is judged that the data format accepted by the granting information acquiring section is stored in the granting information storage.

9. The timestamp administration system according to claim 8, further comprising:
a transmission designation accepting section which accepts designation of causing the confirmation message sending section to send the confirmation message with the timestamp information being attached thereto, the designation being entered by the user, wherein
the controlling section causes the timestamp acquiring section to acquire the timestamp information, and causes the confirmation message sending section to send the confirmation message with the timestamp information being attached thereto, irrespective of the data format accepted by the granting information acquiring section if it is judged that the transmission designation accepting section accepts the designation to send the confirmation message with the timestamp information being attached thereto.

10. The timestamp administration system according to claim 9, wherein
the granting information acquiring section uses information indicating the sender of the data received by the data receiving section, as the granting information, in place of using the data format.

11. The timestamp administration system according to claim 8, wherein
the granting information acquiring section uses information indicating the sender of the data received by the data receiving section, as the granting information, in place of using the data format.

12. The timestamp administration system according to claim 8, further comprising:
a granting number counting section which counts up the number of times of acquiring the timestamp information by the timestamp information acquiring section with respect to each of the granting information, wherein
the controlling section allows the timestamp information acquiring section to acquire the timestamp information up to a predetermined number of times, based on the number of times counted by the granting number counting section.

13. The timestamp administration system according to claim 1, further comprising:
a granting number counting section which counts up the number of times of acquiring the timestamp information by the timestamp information acquiring section with respect to each of the granting information, wherein
the controlling section allows the timestamp information acquiring section to acquire the timestamp information up to a predetermined number of times, based on the number of times counted by the granting number counting section.

14. An image forming apparatus comprising:
a timestamp information acquiring section which acquires timestamp information via a network from a timestamp organization of verifying the time;
a granting information storage which stores one or more granting information indicating granting of acquiring the timestamp information by the timestamp information acquiring section;
a granting information acquiring section which acquires the granting information based on an external input; and
a controlling section which causes the timestamp information acquiring section to acquire the timestamp information if it is judged that the granting information acquired by the granting information acquiring section is stored in the granting information storage.
